(19) United States
(12) Patent Application Publication
(10) Pub. No.: US 2023/0383573 A1
(43) Pub. Date: Nov. 30, 2023

(54) PROTECTION APPARATUS

(71) Applicant: Luxshare Precision Industry Company Limited, SHENZHEN (CN)

(72) Inventors: Haiou Xiao, SHENZHEN (CN); Tingxin Xiao, SHENZHEN (CN); Guoxiang Zhuang, SHENZHEN (CN); Huiyang Qin, SHENZHEN (CN); Guanghong Yu, SHENZHEN (CN)

(73) Assignee: Luxshare Precision Industry Company Limited, SHENZHEN (CN)

(21) Appl. No.: 18/119,989

(22) Filed: Mar. 10, 2023

(30) Foreign Application Priority Data
May 26, 2022 (CN) 202210582021.3

(51) Int. Cl. E05B 47/00; H01M 50/147; E05B 65/00

(52) U.S. Cl. CPC E05B 47/0001; H01M 50/147; E05B 65/006; E05B 2047/0067

(57) ABSTRACT

Embodiments of the present disclosure disclose a protection apparatus, where a protection shell and a protected member are locked by using a first locking part and a second locking part respectively, and the unlocking of the first locking part is controlled by the second locking part by means of a sensor and a controller. Thus, multiple protection of the protected member is achieved by using the first locking part and the second locking part, and a protection effect on the protected member is improved. Meanwhile, when the second locking part unlocks the protection shell during the removal stage of the protected member, the first locking part also unlocks the protected member at the same time, thereby simplifying operation steps of removing the protected member.

### CLAIM OF PRIORITY AND CROSS-REFERENCE TO RELATED APPLICATION(S)

This application claims the benefit of Chinese Patent Application No. 202210582021.3, filed on May 26, 2022, which is incorporated herein by reference in its entirety.

### BACKGROUND OF THE INVENTION

### 1. Field of the Invention

The present disclosure relates to the technical field of device protection, and in particular to a protection apparatus.

### 2. Description of the Related Art

In a device to be equipped with a battery, in order to prevent the battery from being stolen or loosened, a battery protection shell is provided outside the battery. The battery protection shell serves as a barrier for protecting the battery, and may fix and protect the battery. However, the battery may still be loosened and stolen after the battery protection shell is damaged. How to better protect the battery becomes a problem to be solved.

### BRIEF DESCRIPTION OF THE INVENTION

In view of the foregoing, embodiments of the present disclosure provide a protection apparatus that utilizes the matching of a first locking part and a second locking part to improve the protection capability for a protected member and meanwhile facilitate removing the protected member.

The protection apparatus in the embodiments of the present disclosure includes:
a protection shell, covering at least part of an area outside a protected member;
a first locking part, including a first locking member operable to move relative to a protected member;
a second locking part, including a second locking member operable to move relative to the protection shell, where the second locking member has a locking position and an unlocking position arranged at intervals in a movement direction, and the locking position and the unlocking position are respectively used to lock and unlock the protection shell;
a sensor, arranged in the movement direction of the second locking member and configured to generate an in-position signal when the second locking member is in the unlocking position; and
a controller, configured to control, in response to the in-position signal, the first locking part to unlock the protected member.

Further, the protection shell includes:
a receiving recess;
a main plate; and
a ribbed plate, where the ribbed plate and the main plate are respectively used to serve as a bottom and a side wall of the receiving recess, and the receiving recess is used to at least partially receive the protected member;
the second locking part is configured to be located outside the receiving recess and to slide relative to the ribbed plate, and the movement direction of the second locking member is perpendicular to a thickness direction of the main plate.

Further, a first clamp hook is arranged in a protruding manner at one side, facing away from the receiving recess, of the ribbed plate;
the second locking member is a second clamp hook adapted to the first clamp hook;
and the second clamp hook is configured to be clamped with the first clamp hook in the locking position and separated from the first clamp hook in the unlocking position.

Further, the first clamp hook includes a first extension section and a first bending section;
the second clamp hook includes a second extension section and a second bending section, the second extension section is located at one side, close to the unlocking position, of the first extension section, and the first bending section and the second bending section are bent towards the opposite sides of the first clamp hook and the second clamp hook at the same time;
the first bending section includes a first positioning surface and a first guide ramp, the first positioning surface is parallel to the movement direction of the second clamp hook, and the second bending section includes a second positioning surface matching the first positioning surface; and

the first clamp hook is configured to push, by means of the first guide ramp, the second clamp hook to avoid in a direction away from the first clamp hook when the protection shell is fastened on the protected member.

Further, a leading block is arranged in a protruding manner at one side, facing away from the receiving recess, of the ribbed plate, and the leading block corresponds to the unlocking position and has a second guide ramp; and
the second clamp hook is configured to abut, when moving towards the leading block, the second guide ramp in the unlocking position and push the protection shell away from the protected member.

Further, the second locking part further includes a main part and a toggle member, where the main part is fixedly connected to the second clamp hook and has a connection hole opened towards the thickness direction of the main plate; and
the toggle member, having a clamp tongue, is clamped with the main part by means of the matching of the clamp tongue and the connection hole, and located at one side facing the main plate.

Further, the sensor includes a microswitch;
the second locking part further includes the main part and a support arm, the second locking member is fixedly connected to the support arm by means of the main part, and the support arm extends in the movement direction of the second locking member; and
when the second locking member moves to the unlocking position, an end part of the support arm moves to a contact point position of the microswitch.

Further, the second locking part further includes a second positioning member and a second elastic element sleeved on the second positioning member, one end of the second positioning member is fixedly connected to the main part, and the other end extends in movement direction of the second locking member; and
the second elastic element generates an elastic force to reset the second locking member from the unlocking position to the locking position.

Further, the first locking member is a lock tongue, an end part of which has a third positioning surface used to position the protected member and a third guide ramp facing away from the third positioning surface;
the first locking part further includes: a first elastic element, a guide block, a motor and a rotating member;
the guide block has a positioning notch, one end of the guide block is connected to the first elastic element, and the other end is connected to the lock tongue, and the first elastic element is used to generate an elastic force for the lock tongue to move towards the protected member; and
the rotating member has a guide pole and a dial, one end of the guide pole is connected to the dial, and the other end is arranged in the positioning notch in a penetrating manner, a connection position of the guide pole to the dial is spaced from an axis of the dial, and the axis of the dial is connected to an output shaft of the motor; and
the rotating member is configured such that, under the drive of the motor, a side wall of the guide pole abuts against a side wall, away from the lock tongue, of the positioning notch, to drive the lock tongue away from the protected member, and the guide pole is spaced from the side wall, close to the lock tongue, of the positioning notch.

Further, the controller is configured to: control the first locking part to lock the protected member when the time after the first locking part (2) is unlocked exceeds a predetermined time; and/or
maintain an unlocking state of the first locking part when the time after the first locking part (2) is unlocked is less than or equal to the predetermined time.

According to a protection apparatus in the embodiments of the present disclosure, a protection shell and a protected member are locked by using a first locking part and a second locking part respectively, and the unlocking of the first locking part is controlled by the second locking part by means of a sensor and a controller. Thus, multiple protection of the protected member is achieved by using the first locking part and the second locking part, and a protection effect on the protected member is improved. Meanwhile, when the second locking part unlocks the protection shell during the removal stage of the protected member, the first locking part also unlocks the protected member at the same time, thereby simplifying operation steps of removing the protected member.

### BRIEF DESCRIPTION OF THE DRAWINGS

The foregoing and other objectives, features and advantages of the present disclosure will become more apparent from the following description of embodiments of the present disclosure with reference to the accompanying drawings, in which:

FIG. 1 is a schematic structural diagram of one side of a protection apparatus according to an embodiment of the present disclosure;

FIG. 2 is a schematic structural diagram of another side of a protection apparatus according to an embodiment of the present disclosure;

FIG. 3 is a schematic exploded diagram of a second locking part and a protection shell according to an embodiment of the present disclosure;

FIG. 4 is a schematic structural diagram of a second locking part according to an embodiment of the present disclosure;

FIG. 5 is a schematic structural diagram of a first locking part according to an embodiment of the present disclosure;

FIG. 6 is a schematic exploded diagram of a lock tongue and a protected member according to an embodiment of the present disclosure;

FIG. 7 is a schematic diagram of a moving position of a second clamp hook on a ribbed plate according to an embodiment of the present disclosure;

FIG. 8 is a schematic diagram of moving positions of a first locking part and a second locking part according to an embodiment of the present disclosure; and

FIG. 9 is a schematic circuit diagram of a protection apparatus according to an embodiment of the present disclosure.

### DETAILED DESCRIPTION OF EMBODIMENTS OF THE INVENTION

The present disclosure is described below based on the embodiments, but the present disclosure is not limited thereto. In the following detailed description of the present disclosure, certain specific details are described in detail. The present disclosure may be fully understood by those skilled in the art without the description of these detailed parts. In order to avoid confusing the substance of the present disclosure, well-known methods, processes, flows, elements and circuits have not been described in detail.

In addition, it should be understood by those of ordinary skill in the art that the drawings provided herein are for illustrative purposes, and the drawings are not necessarily drawn to scale.

Unless the context clearly requires otherwise, similar words such as “including” and “containing” throughout the application document should be interpreted as inclusive rather than exclusive or exhaustive; that is to say, it means “including but not limited to”.

In the description of the disclosure, it should be understood that the terms “first” and “second” are only used for descriptive purposes, and cannot be understood as indicating or implying relative importance. In addition, in the description of the disclosure, unless otherwise stated, “plurality” means two or more.

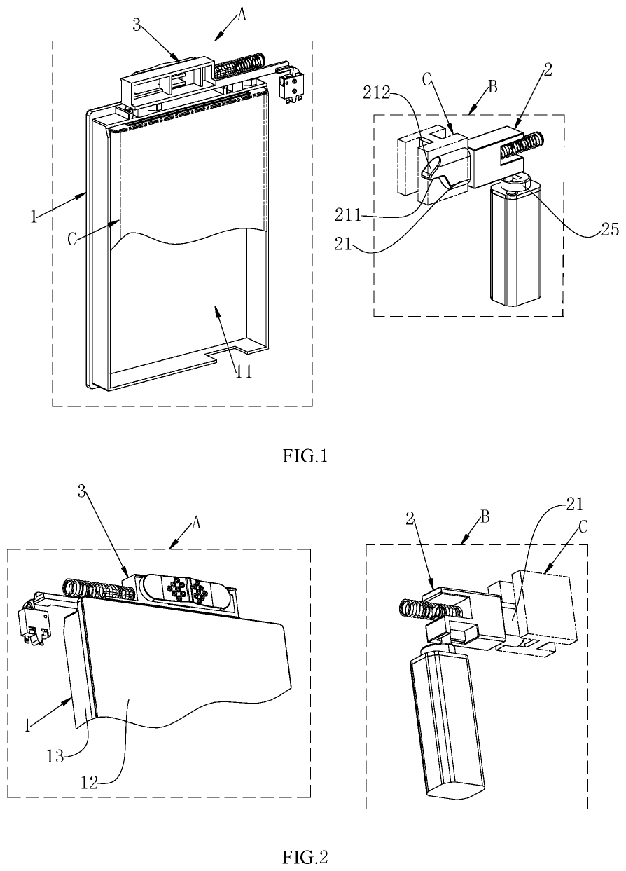

FIGS. 1 and 2 are schematic structural diagrams of the protection apparatus in different directions according to this embodiment. Two dotted boxes in the figures are a second locking module A and a first locking module B respectively, where the second locking module A is used to show the locking on the protection shell 1 and the first locking module B is used to show the locking on the protected member C, and therefore the second locking module A and the first locking module B in the figures are in different positions of the protective apparatus. The dot-dash line in the figure shows the protected member C protected by the protection apparatus. The recess of the protection shell 1 in the figure has a substantially rectangular parallelepiped structure, and the protected member C corresponding thereto also has a substantially rectangular parallelepiped structure, that is, the outer shape of the protection apparatus in the this embodiment may be adjusted according to the shape of the protected member C.

The protected member C in this embodiment includes, but is not limited to, a battery, a spare tire or a helmet, etc. Specifically, taking a battery as an example, the battery may be applied to a device such as a mobile phone, an electric vehicle or a battery-swap station according to different types of the battery. Taking a spare tire as an example, the spare tire may be arranged on a device such as an automobile vehicle or an electric bicycle. Taking a helmet as an example, the helmet may be arranged on a device such as a shared bicycle or a shared electric bicycle. In use, the above device requires that the protected member C be received within the device itself, and that the protected member C be removed from the device in a particular scenario. Taking a helmet as an example, a rider needs to wear the helmet according to the rules before riding the shared electric bicycle. At this time, it is necessary to remove the helmet arranged inside the shared electric bicycle and put it back after use, so as to avoid the theft of the helmet.

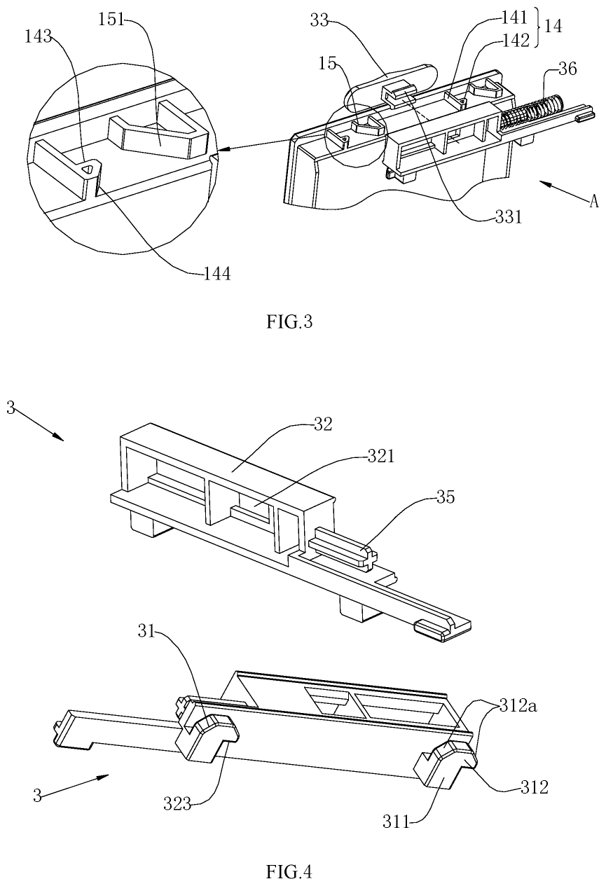

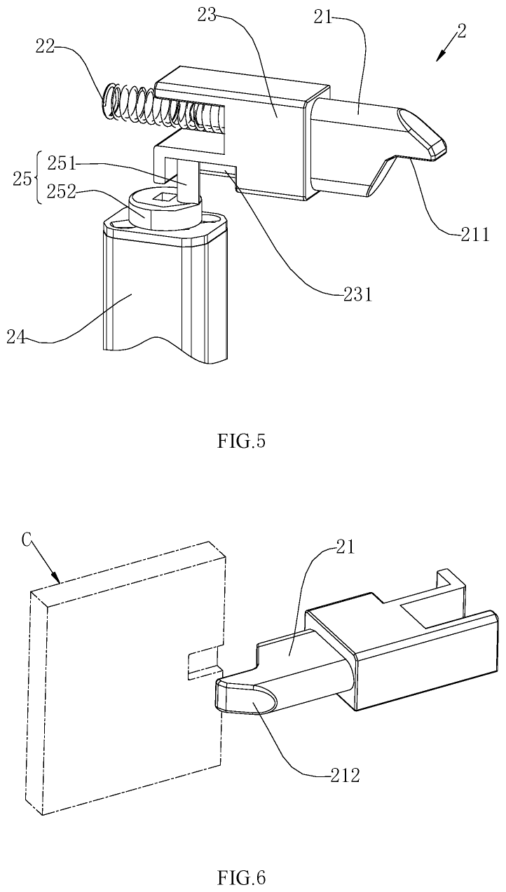

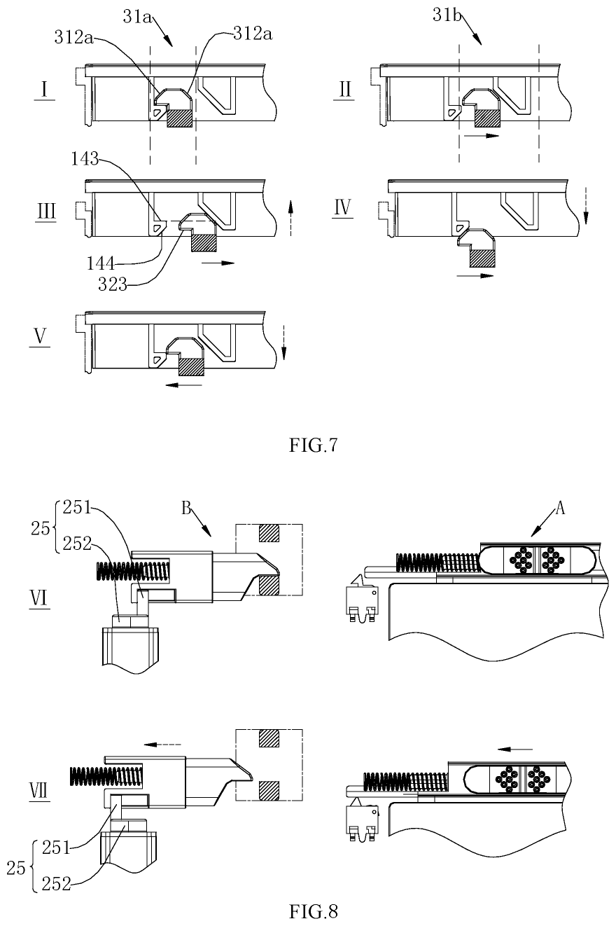

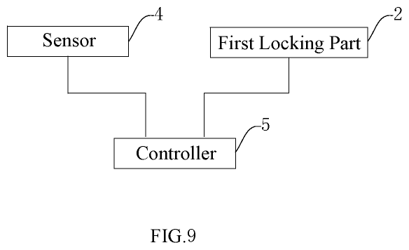

FIG. 3 is a schematic exploded diagram of a second locking part 3 and a protection shell 1, and FIG. 4 is a schematic structural diagram of a second locking part 3. FIG. 5 is a schematic structural diagram of a first locking part 2, and FIG. 6 is a schematic exploded diagram of a lock tongue 21 and a protected member C. The second locking part 3 is driven by a toggle member 33 so that the second locking part 3 may move relative to the protection shell 1, and the first locking part 2 is driven by a motor 24 so that the first locking part 2 may move relative to the protected member C. The states I to VII in FIGS. 7 and 8 are different states in which the first locking part 2 and the second locking part 3 move during the use of the protection apparatus, both being limited by contact of the first locking part 2 and the second locking part 3 with the protected member C and the protection shell 1.

FIG. 9 is a schematic circuit diagram of a protection apparatus. A controller 5 controls the first locking part 2 to unlock or lock based on a signal detected by the sensor 4.

In some implementations, as shown in FIGS. 1 to 9, the protection apparatus of this embodiment includes a protection shell 1 that covers at least part of an area outside a protected member C, a first locking part 2, a second locking part 3, a sensor 4, and a controller 5. The first locking part 2 includes a first locking member operable to move relative to the protected member C, the second locking part 3 includes a second locking member operable to move relative to the protection shell 1, the second locking member has a locking position 31a and an unlocking position 31b arranged at intervals in the movement direction, the locking position 31a and the unlocking position 31b are respectively used to lock and unlock the protection shell 1, the sensor 4 is arranged in the movement direction of the second locking member and is configured to generate an in-position signal when the second locking member is in the unlocking position 31b, and the controller 5 is configured to control, in response to the in-position signal, the first locking part 2 to unlock the protected member C.

It would be readily understood that, as shown in FIG. 9, the protection member C of the this embodiment is located inside the protection shell 1, and the first locking part 2 requires to be at least partially arranged in the inside area of the protection shell 1 in order to facilitate unlocking and locking the protected member C. Thus, the interlock between the second locking part 3 and the first locking part 2 is achieved by means of an electrical signal transmitted between the sensor 4 and the controller 5. In the unlocking state of the second locking member, the first locking member may also be unlocked at the same time in preparation for removing the protected member C.

Optionally, the first locking member and the second locking member in this embodiment are configured to be capable of moving to the inside or surface of the protection shell 1 and the protected member C, thereby playing a limiting role to both. The first locking member and the second locking member may be a limiting pin, a strap or the like capable of playing a limiting role.

According to a protection apparatus in this embodiment, a protection shell 1 and a protected member C are locked by using a first locking part 2 and a second locking part 3 respectively, and the unlocking of the first locking part 2 is controlled by the second locking part 3 by means of a sensor 4 and a controller 5. Thus, multiple protection of the protected member C is achieved by using the first locking part 2 and the second locking part 3, and the protection effect on the protected member C is improved. Meanwhile, when the protected member C is removed, the second locking part 3 unlocks the protection shell 1, so that the first locking part 2 also unlocks the protected member C, thereby simplifying operation steps of removing the protected member C.

In some implementations, as shown in FIGS. 1 to 4, the protection shell 1 includes a receiving recess 11, a main plate 12, and a ribbed plate 13, where the ribbed plate 13 and the main plate 12 are respectively used to serve as a bottom and a side wall of the receiving recess 11 respectively, and the receiving recess 11 is used to at least partially receive the protected member C. Meanwhile, the second locking part 3 is configured to be located outside the receiving recess 11 and to slide relative to the ribbed plate 13, and the movement direction of the second locking member is perpendicular to a thickness direction of the main plate 12. In this embodiment, the second locking member moves relative to the ribbed plate 13 while this direction is parallel to the surface of the main plate 12, thereby enabling the structure of the protection apparatus in this embodiment to be more compact.

If there is no particular description, the following is described by taking an example that the protected member C is a battery used for the electric bicycle. Accordingly, the dash-dot line in FIG. 7 is the main body of the electric bicycle.

Preferably, the receiving recess 11 is configured to receive the partial protected member C, that is, a part of the area of the protected member C is not covered by the ribbed plate 13. In this case, after the protection shell 1 is removed, part of the area of the battery is exposed to the outside of the main body of the electric bicycle. Thus, it is convenient for the rider to remove the battery from the main body of the electric bicycle.

It would be readily understood that the states I to V in FIG. 7 are schematic diagrams of the matching process of the second clamp hook 31 with the first clamp hook 14 and the leading block 15. The states I to III are the process in which the protection shell 1 is detached from the electric bicycle to remove the battery, and the states IV to V are the process in which the protection shell 1 is fastened to the battery after the battery is assembled. The arrow shown by the solid line in the figure shows the movement track of the second clamp hook 14, and the dashed arrow shows the movement track of the protection shell 1.

In some implementations, as shown in FIGS. 1 to 4, a first clamp hook 14 is arranged in a protruding manner at one side, facing away from the receiving recess 11, of the ribbed plate 13. The second locking member is a second clamp hook 31 adapted to the first clamp hook 14, the second clamp hook 31 is configured to be mutually clamped with the first clamp hook 14 in the locking position 31a (shown in state I of FIG. 7) and to be mutually detached from the first clamp hook 14 in the unlocking position 31b (shown in state II of FIG. 7). In this embodiment, the locking between the first locking part 2 and the protection shell 1, that is, the fixing between the protection shell 1 and the main body of the electric bicycle, is achieved by clamping the first clamp hook 14 and the second clamp hook 31 with each other.

Specifically, bending planes of the heads of the first clamp hook 14 and the second clamp hook 31 in this embodiment are perpendicular to the thickness direction of the ribbed plate 13. Thus, the first clamp hook 14 and the second clamp hook 31 may make full use of a space between the ribbed plate 13 and an edge of the main plate 12. Meanwhile, the second locking part 3 is further arranged with a spring that pushes the second clamp hook 31 to move, and the second clamp hook 31 may be reset under the action of the spring.

Further, the first clamp hook 14 includes a first extension section 141 and a first bending section 142. The second clamp hook 31 includes a second extension section 311 and a second bending section 312, the second extension section 311 is located at one side, close to the unlocking position 31b, of the first extension section 141, and the first bending section 142 and the second bending section 312 are bent towards the opposite sides of the first clamp hook 14 and the second clamp hook 31 at the same time. Meanwhile, the first bending section 142 includes a first positioning surface 143 and a first guide ramp 144, the first positioning surface 143 is parallel to the movement direction of the second clamp hook 31, and the second bending section 312 includes a second positioning surface 323 matching the first positioning surface 143 (as shown in FIGS. 4 and 7). The first clamp hook 14 is configured to push, by means of the first guide ramp 144, the second clamp hook 31 to avoid in a direction away from the first clamp hook 14 when the protection shell 1 is fastened on the protected member C. In one aspect, this embodiment achieves that the protection shell 1 may be stably fastened on the outside of the protected member C by using the first positioning surface 143 and the second positioning surface 323, so as to prevent the protection shell 1 from being loosened towards the outside of the protected member C. In another aspect, during the fastening of the protection shell 1 (as shown in state IV of FIG. 7), the first guide ramp 144 facing the side of the second clamp hook 31 may further push the second clamp hook 31 to move to the side, so that the protection shell 1 may be fastened to the outside of the battery, and after the fastening is completed, the second clamp hook 31 is reset under the action of the elastic force of the spring (as shown in state V of FIG. 7).

In some other implementations, a leading block 15 is arranged in a protruding manner at one side, facing away from the receiving recess 11, of the ribbed plate 13, and the leading block corresponds to the unlocking position 31b and has a second guide ramp 151. The second clamp hook 31 is configured to abut, when moving towards the leading block 15, the second guide ramp 151 in the unlocking position 31b and push the protection shell 1 away from the protected member C. In this embodiment, the second guide ramp 151 converts the pushing force in the movement direction of the second clamp hook 31 into a force by which the protection shell 1 is ejected towards the outside of the battery, so that the protection shell 1 may be lifted up when the second locking part 3 is in the unlocking state (shown as state III of FIG. 7), thereby facilitating the rider to easily remove the protection shell 1 from the electric bicycle.

Specifically, in the above embodiment, the first clamp hook 14 and the leading block are respectively located in the locking position 31a and the unlocking position 32b, and when the first clamp hook 14 and the leading block 15 are simultaneously arranged on the ribbed plate, a gap needs to be provided therebetween, and the gap may be selected according to the size of the second bending section 312. That is, the second clamp hook 31 requires to be separated from the first clamp hook 14 before contacting the leading block 15 to avoid interference.

Preferably, as shown in FIG. 4, in order to further achieve good matching of the second clamp hook 31 with the first guide ramp 144 and the second guide ramp 151, two matching surfaces 312a that match the first guide ramp 144 and the second guide ramp 151 respectively are further arranged on the top of the second clamp hook 31. The inclination angle of the two matching surfaces 312a is consistent with the first guide ramp 144 and the second guide ramp 151.

In some implementations, as shown in FIGS. 1 to 4, the second locking part 3 further includes a main part 32 and a toggle member 33, where the main part 32 is fixedly connected to the second clamp hook 31 and has a connection hole 321 opened towards the thickness direction of the main plate 12. The toggle member 33, having a clamp tongue 331, is clamped with the main part 32 by matching of the clamp tongue 331 and the connection hole 321, and located at one side facing the main plate 12. In this embodiment, the toggle member 33 is arranged in a direction towards the outside of the protection shell 1, so that the rider may unlock the protection shell 1 by laterally toggling the toggle member 33.

In some embodiments, as shown in FIGS. 1 to 9, the sensor 4 includes a microswitch. The second locking part 3 further includes the main part 32 and a support arm 34, the second locking member is fixedly connected to the support arm 34 by means of the main part 32, and the support arm 34 extends in the movement direction of the second locking member. When the second locking member moves to the unlocking position 31b, an end part of the support arm 34 moves to the contact point position of the microswitch, so that the microswitch generates an in-position signal.

Further, the second locking part 3 further includes a second positioning member 35 and a second elastic element 36 sleeved on the second positioning member 35, one end of the second positioning member 35 is fixedly connected to the main part 32, and the other end extends in movement direction of the second locking member. The second elastic element 36 generates an elastic force to reset the second locking member from the unlocking position 31b to the locking position 31a. In this embodiment, the second positioning member 35 may provide the second elastic element 36 with positioning and remains stable during compression and resetting of the second elastic element 36, that is, does not run relative to the main part 32.

Specifically, in this embodiment, the second elastic element 36 is a spring. In state VI of FIG. 8, the second locking module A and the first locking module B are both in a locking state (corresponding to state I in FIG. 7), and in state VII, the support arm 34 of the second locking module B moves to the position of the microswitch and presses down the contact point of the microswitch. Accordingly, the first locking member moves towards the left to unlock the battery (corresponding to state II or state III in FIG. 7). The toggle member 33 shown in FIG. 8 is a sliding key, and a plurality of protrusions are arranged on the surface of the sliding key in order to improve the surface friction of the sliding key. After the rider manually toggles the sliding key to the left, the protection shell is lifted. After the sliding key is released, the sliding key is reset by being driven by the spring.

Further, the first locking member is a lock tongue 21, an end part of which has a third positioning surface 211 used to position the protected member C and a third guide ramp 212 facing away from the third positioning surface 211. The first locking part further includes: a first elastic element 22, a guide block 23, a motor 24 and a rotating member 25. The guide block 23 has a positioning notch 231, one end of the guide block 23 is connected to the first elastic element 22, and the other end is connected to the lock tongue 21, and the first elastic element 22 is used to generate an elastic force for the lock tongue 21 to move towards the protected member C. The rotating member 25 has a guide pole 251 and a dial 252, one end of the guide pole 251 is connected to the dial 252, and the other end is arranged in the positioning notch 231 in a penetrating manner, the connection position of the guide pole 251 to the dial 252 is spaced from the axis of the dial 252, and the axis of the dial 252 is connected to the output shaft of the motor 24 (as shown in FIGS. 5 and 8). The rotating member 25 is configured such that, under the drive of the motor 24, a side wall of the guide pole 251 abuts against a side wall, away from the lock tongue 21, of the positioning notch 231, to bring the lock tongue 21 away from the protected member C, and the guide pole 251 is spaced from the side wall, close to the lock tongue 21, of the positioning notch 231.

As shown in FIG. 8, in this embodiment, the guide pole 251 and the output shaft of the motor 24 are in an eccentric state, and when the guide pole 251 is arranged in the positioning notch 231 in a penetrating manner, the side wall of the guide pole 251 may abut against the inner wall of the positioning notch 231 as the battery rotates, thereby driving the lock tongue 21 to move. The guide pole 251 in the state VI of the figure is located on the right side of the rotation axis of the motor 24, and after an electrode is rotated by 180°, the guide pole 251 in the state VI is located on the left side of the rotation axis of the motor 24, and at this time, the lock tongue 21 is removed from the recess of the battery. In this embodiment, the automatic control of the battery locking by the first locking part 2 is achieved by means of the matching of the motor 24, the rotating member 25, the guide block 23 and the first elastic element 22, thereby improving the automation level of the protection apparatus.

It would be readily understood that in this embodiment, when the guide pole abuts the side wall to the left of the positioning notch 231, the guide pole still has a large gap with the side wall to the right of the positioning notch 231. In this case, the lock tongue 21 has the freedom to move to the left in the figure. That is, when it is required to put the battery into the electric bicycle, even if the lock tongue 21 is in the locking state, the battery is directly pressed into the battery mounting position, and the battery contacts with the third guide ramp 212 and pushes the lock tongue 21 to move to the left to avoid the battery. After the battery is mounted, the lock tongue 21 is reset under the action of an elastic force to lock the battery. As shown in FIG. 6, the battery in the figure is arranged with a recess corresponding to the third positioning surface 211, and the lock tongue 21 may be clamped therein after the battery is mounted.

In some implementations, as shown in FIGS. 1 to 9, the controller 5 is configured to control the first locking part 2 to lock the protected member C when the time after the first locking part 2 is unlocked exceeds a predetermined time. At the same time, an unlocking state of the first locking part 2 is maintained when the time after the first locking part 2 is unlocked is less than or equal to the predetermined time. In this embodiment, the first locking part 2 is arranged as automatic locking, improving further protection for the battery. The case that the battery is stolen or detached from the electric bicycle due to the battery being unlocked by the rider who accidentally touches the toggle member 33 when using the electric bicycle is avoided. In this case, it takes a certain amount of time for the rider to unlock and remove the protection shell 1, and in this embodiment, the first locking part 2 may be kept open for a certain amount of time to prevent premature locking thereof. Thus, the predetermined time may be set as two to three minutes.

The protection apparatus in the above embodiments may be used as follows. In some implementations, as shown in FIGS. 1 to 9, during the charging phase of the battery, the rider unlocks the protection shell 1 by toggling the sliding key, so that the protection shell 1 is lifted from the main body of the electric bicycle. In this case, the second clamp hook 31 is in the unlocking position and drives the support arm 34 to trigger the microswitch. Then, after acquiring the in-position signal of the microswitch, the controller 5 controls the motor 24 to rotate so as to drive the lock tongue 21 to unlock the battery, the rider first removes the protection shell 1 and then removes the battery, and the controller 5 automatically resets the lock tongue 21 after unlocking the battery for one minute. In the battery mounting stage, the rider directly puts the battery into the battery mounting position of the main body of the electric bicycle, when the edge of the battery contacts the third guide surface 212, the lock tongue 21 is pushed by the battery and moves away from the battery, so that the battery is put in, and then the battery is locked. Then, the rider fastens the protection shell 1 on the battery, and at this time, the matching surface 312a and the first guide ramp 144 are fitted with each other, and as the protection shell 1 is continuously pressed in, the second clamp hook 31 avoids the first clamp hook 14 until the protection shell is mounted in place. Finally, the second clamp hook 31 is reset to achieve mutual clamping of the first clamp hook 14 and the second clamp hook 31.

The above description is only the preferred embodiment of the present disclosure and is not intended to limit the present disclosure, and various modifications and changes may be made in the present disclosure for those skilled in the art. Any modification, equivalent replacement, or improvement made within the spirit and principle of the present disclosure should be inclusive in the protection scope of the present disclosure.

I/We claim:

1. A protection apparatus, comprising:
a protection shell (1), covering at least part of an area outside a protected member;
a first locking part (2), comprising a first locking member (21) operable to move relative to a protected member;
a second locking part (3), comprising a second locking member operable to move relative to the protection shell (1), wherein the second locking member has a locking position (31a) and an unlocking position (31b) arranged at intervals in a movement direction, and the locking position (31a) and the unlocking position (31b) are respectively used to lock and unlock the protection shell (1);
a sensor (4), arranged in the movement direction of the second locking member and configured to generate an in-position signal when the second locking member is in the unlocking position (31b); and
a controller (5), configured to control, in response to the in-position signal, the first locking part (2) to unlock the protected member.

2. The protection apparatus according to claim 1, wherein the protection shell comprises:
a receiving recess (11);
a main plate (12); and
a ribbed plate (13), wherein the ribbed plate (13) and the main plate (12) are respectively used to serve as a bottom and a side wall of the receiving recess (11), and the receiving recess (11) is used to at least partially receive the protected member;
the second locking part (3) is configured to be located outside the receiving recess (11) and to slide relative to the ribbed plate (13), and the movement direction of the second locking member is perpendicular to a thickness direction of the main plate (12).

3. The protection apparatus according to claim 2, wherein a first clamp hook (14) is arranged in a protruding manner at one side, facing away from the receiving recess (11), of the ribbed plate (13);
the second locking member is a second clamp hook (31) adapted to the first clamp hook (14); and
the second clamp hook (31) is configured to be clamped with the first clamp hook (14) in the locking position (31a) and separated from the first clamp hook (14) in the unlocking position (31b).

4. The protection apparatus according to claim 3, wherein the first clamp hook (14) comprises a first extension section (141) and a first bending section (142);
the second clamp hook (31) comprises a second extension section (311) and a second bending section (312), the second extension section (311) is located at one side, close to the unlocking position (31b), of the first extension section (141), and the first bending section (142) and the second bending section (312) are bent towards the opposite sides of the first clamp hook (14) and the second clamp hook (31) at the same time;
the first bending section (142) comprises a first positioning surface (143) and a first guide ramp (144), the first positioning surface (143) is parallel to the movement direction of the second clamp hook (31), and the second bending section (312) comprises a second positioning surface (323) matching the first positioning surface (143); and
the first clamp hook (14) is configured to push, by means of the first guide ramp (144), the second clamp hook (31) to avoid in a direction away from the first clamp hook (14) when the protection shell (1) is fastened on the protected member.

5. The protection apparatus according to claim 2, wherein a leading block (15) is arranged in a protruding manner at one side, facing away from the receiving recess (11), of the ribbed plate (13), and the leading block (15) corresponds to the unlocking position (31b) and has a second guide ramp (151); and
the second clamp hook (31) is configured to abut, when moving towards the leading block (15), the second guide ramp (151) in the unlocking position (31b) and push the protection shell (1) away from the protected member.

6. The protection apparatus according to claim 3, wherein the second locking part (3) further comprises a main part (32) and a toggle member (33), and the main part (32) is fixedly connected to the second clamp hook (31) and has a connection hole (321) opened towards the thickness direction of the main plate (12); and
the toggle member (33) has a clamp tongue (331), is clamped with the main part (32) by means of the matching of the clamp tongue (331) and the connection hole (321), and is located at one side facing the main plate (12).

7. The protection apparatus according to claim 1, wherein the sensor (4) comprises a microswitch;
the second locking part (3) further comprises the main part (32) and a support arm (34), the second locking member is fixedly connected to the support arm (34) by means of the main part (32), and the support arm (34) extends in the movement direction of the second locking member; and
when the second locking member moves to the unlocking position (31b), an end part of the support arm (34) moves to a contact point position of the microswitch.

8. The protection apparatus according to claim 7, wherein the second locking part (3) further comprises a second positioning member (35) and a second elastic element (36) sleeved on the second positioning member (35), one end of the second positioning member (36) is fixedly connected to the main part (32), and the other end extends in the movement direction of the second locking member; and
the second elastic element (36) generates an elastic force to reset the second locking member from the unlocking position (31b) to the locking position (31a).

9. The protection apparatus according to claim 1, wherein the first locking member is a lock tongue (21), an end part of which has a third positioning surface (211) used to position the protected member and a third guide ramp (212) facing away from the third positioning surface (211);
the first locking part (2) further comprises: a first elastic element (22), a guide block (23), a motor (24) and a rotating member (25);
the guide block (23) has a positioning notch (231), one end of the guide block (23) is connected to the first elastic element (22), and the other end is connected to the lock tongue (21), and the first elastic element (22) is used to generate an elastic force for the lock tongue (21) to move towards the protected member; and
the rotating member (25) has a guide pole (251) and a dial (252), one end of the guide pole (251) is connected to the dial (252), and the other end is arranged in the positioning notch (231) in a penetrating manner, a connection position of the guide pole (251) to the dial (252) is spaced from an axis of the dial (252), and the axis of the dial (252) is connected to an output shaft of the motor (24); and
the rotating member (25) is configured such that, under the drive of the motor (24), a side wall of the guide pole (251) abuts against a side wall, away from the lock tongue (21), of the positioning notch (231), to drive the lock tongue (21) away from the protected member, and the guide pole (251) is spaced from the side wall, close to the lock tongue (21), of the positioning notch (231).

10. The protection apparatus according to claim 1, wherein the controller (5) is configured to: control the first locking part (2) to lock the protected member when the time after the first locking part (2) is unlocked exceeds a predetermined time; and/or
maintain an unlocking state of the first locking part (2) when the time after the first locking part (2) is unlocked is less than or equal to the predetermined time.
